(19) United States
(12) Patent Application Publication
(10) Pub. No.: US 2003/0072052 A1
(43) Pub. Date: Apr. 17, 2003

(54) Optical wavelength plan for metropolitan photonic network

(76) Inventors: Alan F. Graves, Kanata (CA); John H. Watkins, Ottawa (CA); Chris Hobbs, Ottawa (CA)

Correspondence Address: GOWLING LAFLEUR HENDERSON, Suite 2600, 160 Elgin Street, Ottawa, ON, K1P 1C3, CA

(21) Appl. No.: 09/972,989

(22) Filed: Oct. 10, 2001

(51) Int. Cl. H04J 14/02

(52) U.S. Cl. 359/124; 359/128

(57) ABSTRACT

An optical wavelength plan for metropolitan photonic networks uses a cost-effective DWDM optimized architecture allowing the introduction of DWDM into the metro network. In order to implement this architecture cost-effective ways of implementing the optical carrier frequency/wavelength precision required for a Dense Wavelength Division Multiplexing 100 GHz or 50 GHz on-grid solutions are needed. The optical wavelength plan provides WDM density to the access portion of the metropolitan photonic network and DWDM density to the core photonic network. The optical wavelength distribution methods allocate wavelength in the access network in order to optimize non-blocking traffic throughput to the core network.

The present application is related in subject matter to co-pending U.S. application Ser. No. 09/511,065, entitled “Switch For Optical Signals”, filed on Feb. 23, 2000, assigned to the Assignee of the present invention and hereby incorporated by reference herein in its entirety. The present application is also related in subject matter to co-pending U.S. application Ser. No. 09/703,631 entitled “Optical Switching System for Switching Optical Signals in Wavelength Groups”, filed on Nov. 2, 2000, assigned to the Assignee of the present invention and hereby incorporated by reference herein in its entirety. The present application is also related in subject matter to co-pending U.S. application Ser. No. 09/703,002 entitled “Photonic Network Node”, filed on Feb. 15, 2001, assigned to the Assignee of the present invention and hereby incorporated by reference herein in its entirety. The present application is also related in subject matter to co-pending U.S. application Ser. No. 09/453,282 entitled “Architectures for Communications Networks”, filed on Dec. 3, 1999 assigned to the Assignee of the present invention and hereby incorporated by reference herein in its entirety. The present application is further related, in subject matter, to co-pending U.S. application Ser. No. 09/870,665 entitled “Wavelength Distribution Architecture and implementation for a Photonically Switched Network”, filed on Jun. 1, 2001 assigned to the Assignee of the present invention and hereby incorporated by reference herein in its entirety. The present invention is also related, in subject matter, to co-pending U.S. application Ser. No. 09/893,498 entitled “Metropolitan Photonic Switch”, filed Jun. 29, 2001 and assigned to the Assignee of the present invention and hereby incorporated by reference herein in its entirety. The present application is further related, in subject matter, to co-pending U.S. application Ser. No. 09/893,493 entitled “Communications Network For A Metropolitan Area”, filed on Jun. 29, 2001 and assigned to the Assignee of the present invention and hereby incorporated by reference herein in its entirety.

### FIELD OF THE INVENTION

The present invention relates to photonic networks and is particularly concerned with optical wavelength plans for metropolitan area networks.

### BACKGROUND OF THE INVENTION

A photonic network requires precisely controlled (in optical carrier frequency) modulated optical carriers from the customer premises for a DWDM core photonic network to be viable, since these optical carriers have to align, in optical frequency, with the centre frequencies of the individual DWDM channels they are using. In prior art solutions, all optical carriers are locally generated at the access point. If fixed optical carrier frequency lasers are used, network engineering of distribution of laser wavelengths must be mapped out on a network wide basis, which is difficult to do, especially in a dynamic network. Alternatively, individual tunable lasers can be used at all access points, providing greater flexibility in network engineering at a significant increase in hardware costs, and a need to introduce remote optical frequency provisioning. Furthermore, such sources, static or tunable are required to offer optical carriers at frequencies precise enough to meet the passband centering requirements of the individual passbands of the DWDM network.

### SUMMARY OF THE INVENTION

According to an aspect of the present invention an optical wavelength plan for metropolitan area networks concatenates wavelengths used in access equipment to be compatible with the DWDM core network for transmission to a network core without wavelength conversion, and provides means for distributing optical carriers from a centralized multi-optical carrier source to the customer premises and returning the modulated signal to the network.

### BRIEF DESCRIPTION OF THE DRAWINGS

These and other features of the invention will become more apparent from the following description in which reference is made to the appended drawings in which:

FIG. 1 illustrates in a block diagram a photonic network for implementing an embodiment of the present invention;

FIG. 2 graphically illustrates a first wavelength plan for the network of FIG. 1;

FIG. 3 graphically illustrates the first wavelength plan of FIG. 2 as applied to the downstream path from network to access for specific access nodes and edge nodes of FIG. 1;

FIG. 4 graphically illustrates the first wavelength plan of FIG. 2 as applied to the upstream path from access to network;

FIG. 5 illustrates in more detail, a portion of the network of FIG. 1 showing wavelength distribution at the access portion thereof;

FIG. 6 illustrates in more detail, the portion of the network of FIG. 5 showing the 1310 nm control path and the implementation at the OSP (Outside Plant) optical mux/demux;

FIG. 7 illustrates in more detail, a portion of the network of FIG. 5 showing wavelength distribution at the access portion thereof, showing an option of a field (OSP) located lambda routing switch;

FIG. 8 illustrates in more detail, a portion of the network of FIG. 1 showing wavelength distribution at the access portion thereof in the case of a practical network using 32 lambda DWDM;

FIG. 9 illustrates the optical path of the core-to-access direction of a metropolitan photonic network switch configured for implementing the wavelength plan of FIG. 5c;

FIG. 10 illustrates the optical path of the access-to-core direction of a metropolitan photonic network switch configured for implementing the wavelength plan of FIG. 5c;

FIG. 11 illustrates in more detail, a wavelength assignment in an edge node of FIG. 1;

FIG. 12 illustrates the edge node of FIG. 11 including lambda concentration according to a first model;

FIG. 13 illustrates the edge node of FIG. 11 including lambda concentration according to a second model;

FIG. 14 illustrates the edge node of FIG. 11 including lambda concentration according to a more detailed representation of the top path of FIG. 13;

FIG. 15 illustrates the edge node of FIG. 11 including lambda concentration according to a fourth model; and

FIGS. 16-20 graphically illustrate results for various algorithms modeled for different conditions.

### DETAILED DESCRIPTION OF THE PREFERRED EMBODIMENT

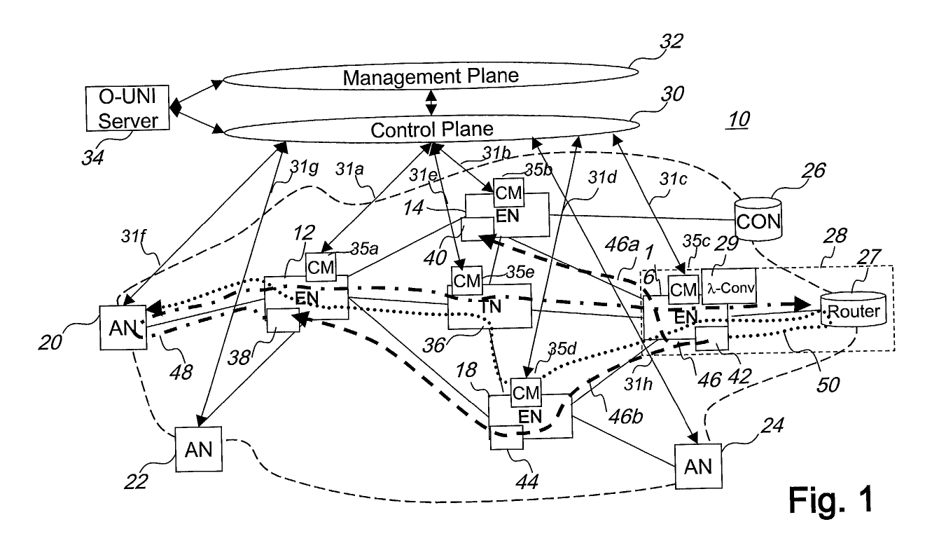

Referring to FIG. 1, there is illustrated in a block diagram a photonic network for implementing an embodiment of the present invention. The metropolitan photonic network 10 includes a plurality of network nodes in the form of metropolitan photonic nodes 12, 14, 16, 17, and 18 providing edge node, tandem node or mixed edge/tandem node functionality which are interconnected to form an optical mesh network. The edge nodes are connected to access nodes that terminate the optical network, for example photonic edge nodes (EN) 12 and 18 are coupled to access nodes (AN) 20 and 22, and 24 respectively, while edge nodes 14 and 16 are coupled to content switch 26 and MPLS router 27, respectively. The photonic edge node 16 and the router 27 are closely coupled to form a core node 28 and include a lambda converter 29. Other core nodes may also house gateways to long-haul networks, or this may also be housed in the same core node as the router 27. In the event that the core node is of a high capacity (which will tend to be the case), enough instantiations of each optical carrier frequency can be provided that, in normal operation, there is no need to lambda-convert the traffic to/from the routers, LH gateways, etc. since such traffic will be processed electronically at these functions and mapped back on to the appropriate lambda for onward propagation. In this case the lambda converter need be sized only to cover end-to-end intra-metro clear-lambda transport which is a minority of traffic (15% or less). In the event that the core node router or LH gateway does not provide enough instantiations of each lambda, then the lambda-converter will also have to lambda-convert some of the traffic to the electro-optic functions. All network nodes are coupled to a network control plane 30 via links 31, which is itself coupled to a management plane 32. By way of example an Optical UNI server 34 is shown coupled to the management and control planes 30 and 32. These planes also interface with other applicable protocol servers as appropriate for the network configuration (e.g. Internet Protocol, Ethernet). All nodes in the core network include a contact manager (CM) 35 coupled to the control plane 30. The control plane 30 can be implemented as a 100 bT Ethernet network using 1310 nm and coarse-WDM (true 1300/1500 band-level coarse WDM) to combine the 100 bT 1300 nm control/signaling sub-net with the multiple 15xx nm carriers of the DWDM traffic channels on inter-switch node fibers. Each switch node is associated with a small Ethernet hub/switch (not shown in FIG. 1) for passing through Ethernet packet info and extracting local communications to/from local node controller and Contract Manager. Each edge node 12, 14, 16, and 18 includes a multi-lambda carrier source 38, 40, 42, and 44, respectively, for the purpose of supplying appropriate unmodulated optical carriers to the plurality of access nodes subtending the edge node.

In operation, network 10, when implementing an embodiment of the present invention, provides network end-to-end transport based upon the allocation of optical carriers of specific wavelengths and implement the distribution of the appropriate optical carriers to achieve the required end-to-end wavelength path connection across the network. Access node #X (or router #Y) requests a cross-network path by sending a request to the photonic network control plane, specifically the O-UNI, via links 31. The control-plane passes the requests to the O-UNI server, which establishes the validity of the request and the locations of the optical path end points for the optical path to be set up or taken down, as well as any GoS, QoS constraints. The O-UNI, via the control plane, notifies the Contract Managers (CM's) at the individual edge nodes and tandem nodes either the required end-to-end path and lets them collaborate to find one (the optical network controller (ONC), Contract Manager model as described in co-pending U.S. application Ser. No. 09/453,282 entitled “Architectures for Communications Networks”, filed on Dec. 3, 1999 assigned to the Assignee of the present invention.) or the management/control plane determines an available end-to-end path, including cross-connections in the edge nodes and lambdas to use, and notifies the affected nodes. The edge nodes then set up the correct connections and the adjacent lambda source feeds the correct lambda to the access node #X. The access does not need to know what wavelength it is using, since this is managed within the network to ensure appropriate photonic connectivity. Once complete the access node is notified that its lambda-path is in place. For the access nodes, links 31f, 31g, and 31h service (lambda) requests to O-UNI and returns notification of grants of lambda requests. For the photonic nodes, links 31a-31e handle end-to-end bandwidth requests (lambda) from O-UNI 34 to CM 35. Inter-CM communications are used to establish the components of the end-to-end path. Upon path establishment, confirmation of path is sent to O-UNI 34 from CM35.

The optical carrier to be modulated is provided as a clean unmodulated optical carrier from a local source, co-located with the edge node, along with the downstream data on a separate optical carrier of a different optical frequency which originates at the far end of the network path. There may be some co-ordination between the optical carriers to simplify the provisioning process, e.g. odd lambda downstream data-stream is associated with the next highest lambda for the upstream data (and hence downstream optical unmodulated carrier) or even lambda downstream gets next lower odd lambda upstream, which allows all lambdas to be used. In addition the multi-lambda carrier sources associated with each switch node can be synchronized to a master optical carrier, generated in one of the Multi-lambda sources (MLS). This is described in more detail, especially with respect to the implementation of the MLS, MLS synchronization technique in co-pending application filed Jun. 1, 2001, Ser. No. 60/294,919; hereinafter referred to as (MLS synch). For example, for the purpose of synchronization, a designated master multi-lambda carrier source 42, associated with EN16, generates a reference lambda carrier 46, which is sent to all remaining multi-lambda carrier sources in the network, 46a going to the multi-lambda carrier source 40 and 46b going to multi-lambda carrier sources 44 and 38. These multi-lambda carrier sources then generate their multi-lambda carriers with reference to carrier 46. For example, the multi-lambda carrier source 38 of edge node 12 generates a carrier 48 which is output to AN20, where it is modulated and returned to the network via 12, 36, 16 until it terminates on router 28. Meanwhile the multi-lambda carrier source 42 of edge node 16 generates a carrier 50 which it outputs to router 28, which modulates it, returns it to the network via 16, 44, 36, 12 to terminate on 20, thereby completing the bi-directional path.

The detailed structure of the switch edge-facing or access-facing port card depends upon the actual wavelength allocation methodology, and the required network and hence node functionality, but all approaches use the method of providing the originating optical carrier from a centralized source at a specific wavelength as laid out herein. The control plane 30 and management plane 32 both couple across to the Ethernet control, management planes as well as to the Optical UNI server 34 (Optical User-Network Interface Server). The photonic network 10 is quasi-autonomous, and configures its wavelength paths based upon requests for end-to-end connectivity passed to the O-UNI Server. This server then notifies each node of the required new end-to-end path and the nodes co-operate to establish such a path. Methods to do this were disclosed in co-pending U.S. application Ser. No. 09/453,282 entitled “Architectures for Communications Networks”, filed Dec. 3, 1999, referred to herein after as (Graves Hobbs 1999). Such operation permits simplification in layer 2, 3 (L2, L3) network topology by permitting reconfigurable bypass and cost effective access to centralized network L2 and L3 resource. An end-to-end lambda provisioned photonic network greatly reduces component count seen in opto-electronic hybrid networks. For example in traversing the network of FIG. 1 from access node 20 to access node 24 (or any other nodes e.g. 20, 28, 26, 44 to 24), there are only two optical transmitters and two optical receivers over the entire path in each direction, down from a typical of 8 if electrical switching cores were used in a sparse-mesh configuration and even higher in ring or multi-ring structures.

The photonic network 10 implementing an embodiment of the present invention uses a cost-effective DWDM optimized switch architecture, which provides the opportunity to introduce both enormous growth and bandwidth-carrying capacity of DWDM into the metro network. In order to implement this architecture it is necessary to provide cost-effective ways of implementing the optical carriers with the frequency or wavelength precision required for a 100 GHz, 50 GHz or even 25 GHz or less on-grid DWDM solution. This has two aspects, one being the precision of the DWDM (dense wavelength division multiplexing), DWDD (dense wavelength division demultiplexing) actual multiplexing, demultiplexing elements and the other being the precision generation of the optical carriers themselves, since these optical carriers have to be centered in the passbands of the individual DWDM channels, if their modulation sidebands are to pass through the DWDM path without significant impairment. These requirements become much more stringent as the grid spacing is reduced and eventually requires the locking of all of the optical carriers to a master reference lambda, to remove the effects of plesiochronous working. This favours the use of a centralized multi-lambda source, which can be locked once per edge node, to the incoming reference optical frequency and then can generate the other required optical frequencies with precise offsets. Such a capability to lock to an incoming reference is included in the Multi-lambda source described in co-pending application U.S. Provisional No. 60/294,919. In addition, as pass-bands are moved closer together an active method of keeping the DWDM filters/mux'es on grid to sufficient accuracy is needed. This can also be implemented by locking these parts (e.g. by thermal tuning) to the master synchronization lambda.

DWDM multiplexers and demultiplexers are rapidly falling in cost and complexity as Array Waveguide technology matures to the point of offering adequate performance. This technology results in a single chip monolithic part that can be manufactured using a silicon wafer processing plant and techniques. Furthermore such parts exhibit accuracies to a few GHz in commercially available devices, making 50 GHz and 100 GHz DWDM applications of this technology highly viable, with a relatively straight-forward evolution to greater grid densities still. For 100 GHz and 50 GHz working such parts often have relatively flat passbands of about +/−12-20 GHz either side of their center frequency. Given that the modulation sidebands may extend out—10 GHz either side of the carrier, this leaves little margin for the combined effects of DWDM filter drift and optical carrier frequency drift, leading to a requirement for a very precise and hence potentially very expensive optical carrier source. Such sources could be placed in the ANs but would then have to be provisioned individually, and would be hard to synchronize due to their remote location, thus requiring more precise free-running operation, further adding to their cost. This becomes even more of an issue when the grid is reduced to 25 or 12.5 GHz in which case each pass-band is expected to be less than that required to support a 10 Gb/s bit stream so such grid densities will only find utility for 1-2.5 Gb/s and below traffic rates.

Drawbacks of Locating Lambda Sources in ANs

Number of sources needed equals number of access optical carriers whereas central location requires only one source for each utilized wavelength value if splitter & amplifiers are used

Inability to lock, sychronize

Need for lambda-provisioning, which means the AN becomes lambda-aware

Need for lambda verification to check that the AN source has been correctly set

Need to duplicate the sources and locking mechanisms at each and every AN

Potentially an exposure to a hostile environment, especially in the external outside plant or some CLE equipment rooms.

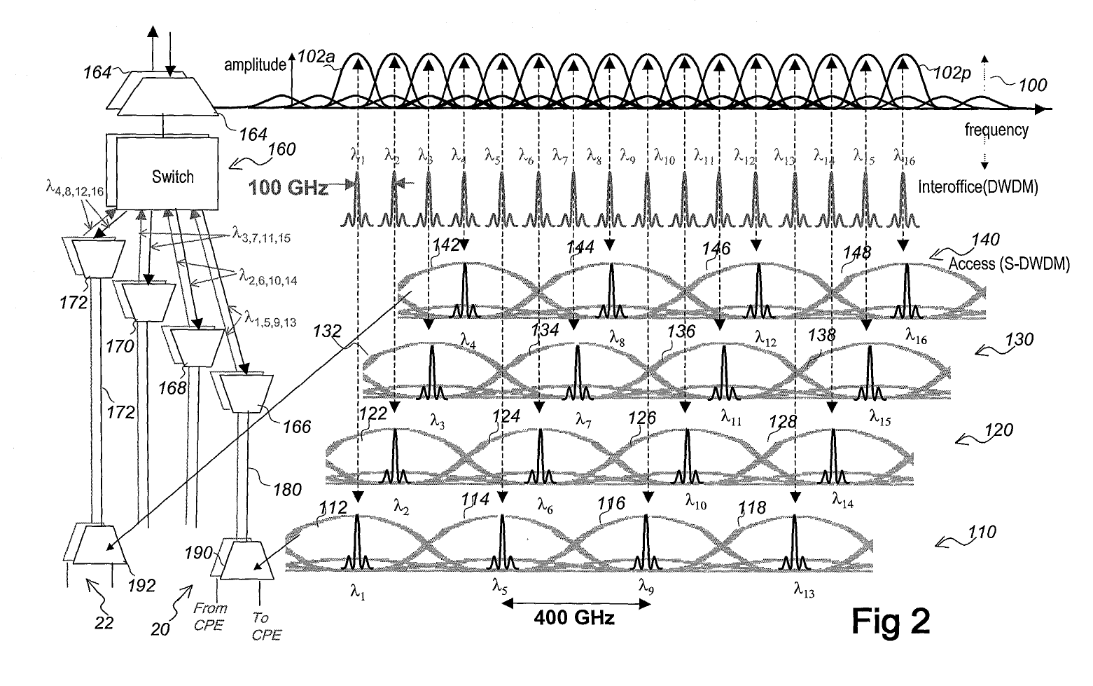

Referring to FIG. 2, there is graphically illustrated a wavelength plan for the network of FIG. 1. The wavelength plan includes a simplified DWDM plan having sixteen (16) wavelengths in this example and a simplified sparse DWDM plan having four wavelength groups of four wavelengths each in this example. The DWDM wavelength plan 100 includes sixteen (16) wavelengths (λ₁, . . . ,λ₁₆) with representative response curves for the DWDM filter having peaks 102a through 102p. Corresponding sparse DWDM plan for the access network includes a first wavelength group 110 having grouped dense wavelengths division multiplex response curves or sparse-DWDM response curves 112, 114, 116 and 118 which include wavelength λ₁, λ₅,λ₉,λ₁₃. Similarly, wavelengths group 120 shows curves 122, 124, 126, 128, which includes wavelengths λ₂,λ₆,λ₁₀,λ₁₄; wavelength group 130 shows response curves 132, 134, 136, 138 which include wavelengths λ₃,λ₇,λ₁₁,λ₁₅; and wavelengths group 140 shows curves 142, 144, 146, 148, which include wavelengths λ₄,λ₈,λ₁₂,λ₁₆. The DWDM plan includes wavelengths having a spacing of 100 GHz while the sparse WDM access plan has a 400-GHz spacing between wavelengths. Note that the four S-DWDM mux, demux responses 110, 120, 130, 140 have individual demuxed output or input lobes centred 400 GHz apart within each mux or demux, but that each mux-demux is specific to a particular S-DWDM group, and is offset 100 GHz from each of its neighbour groups. Hence there are four different, but similar filter types/demux/mux types. The characteristics of the wavelengths used are the same in both the DWDM plan and the sparse DWDM plan so that the optical carriers are at sufficiently precise wavelengths to pass from the access side of the network to the core side of the network without having to be regenerated. Similarly optical carrier wavelengths passing from the DWDM core can move into the access portion without modification.

For example, edge node 12 of FIG. 1 includes a photonic switch core 160, DWDM demux 162 and mux 164 and sparse-DWDM muxes 166, 168, 170 and 172. The sparse-DWDM muxes are coupled to access nodes 20 and 22 via optical fibers 180 and 182, respectively. The access nodes 20 and 22 include sparse-DWDM demuxes 190 and 192 respectively and de-interleavers 194 and 196 respectively.

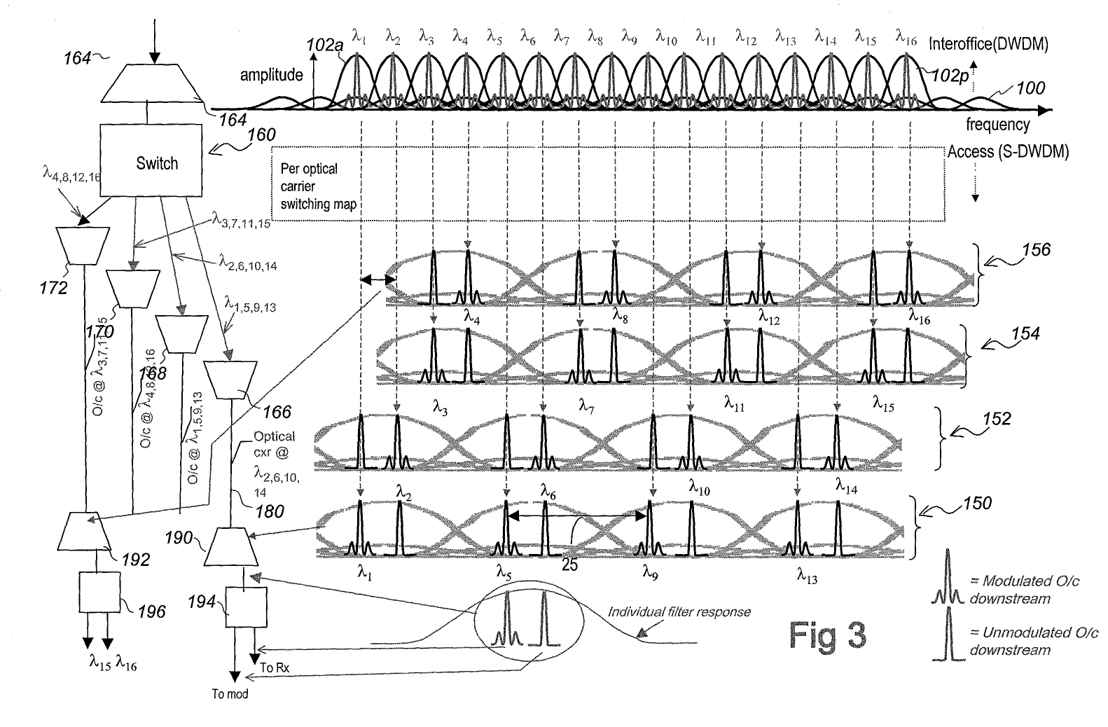

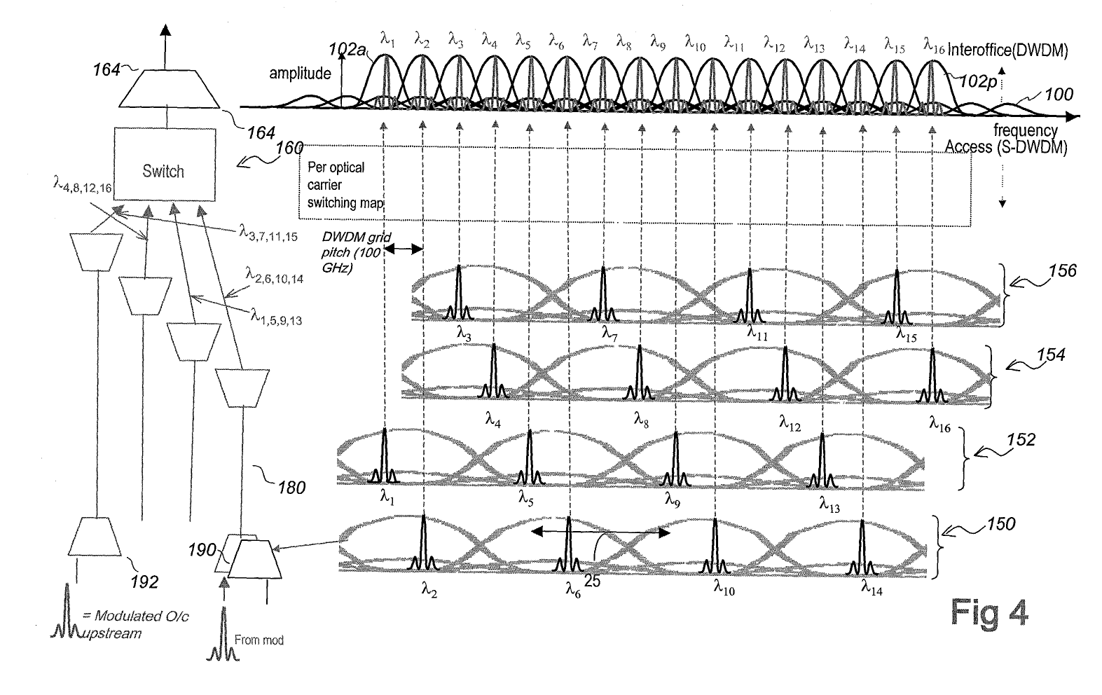

Referring to FIGS. 3 and 4, there is graphically illustrated the first wavelength plan of FIG. 2 as applied to specific access nodes of FIG. 1 in the downstream (FIG. 3) and upstream (FIG. 4) directions. In applying the wavelength plan to specific access nodes, adjacent wavelengths are selected for the downlink and uplink optical paths on the access fiber. For the example of FIGS. 3 and 4, wavelength groups 110 and 120 are combined to form wavelength delivery group 150 (downlink) in providing downstream wavelengths λ₁₂,λ₆,λ₁₀, and λ₁₄ (even numbered) for modulater at the access node 20 to become upstream traffic and modulated wavelength λ₁,λ₅,λ₉, and λ₁₃ (odd numbered) carrying downstream (downlink) traffic. Similarly, wavelength groups 130 and 140 are combined to form wavelength delivery group 156. Note that in wavelength delivery group 156 the odd numbered wavelengths are unmodulated (in the downlink direction) while the even numbered wavelengths are moduled, carrying the downstream traffic. Note that details of the photonic metropolitan network and phontonic metropolitan nodes are provided in the related co-pending applications referenced herein above. Because downstream traffic and upstream traffic carried on separate fibers are between the access nodes 20 and 22 and the edge node 12, the four wavelength groups can be combined to form four wavelength delivery groups 150, 152, 154, 156 by changing the wavelength group that provides the unmodulated downstream wavelengths. Also note that the four phases of S-DWDM can now be carried on just two different filter responses 200 GHz apart (for 100 GHz DWDM)

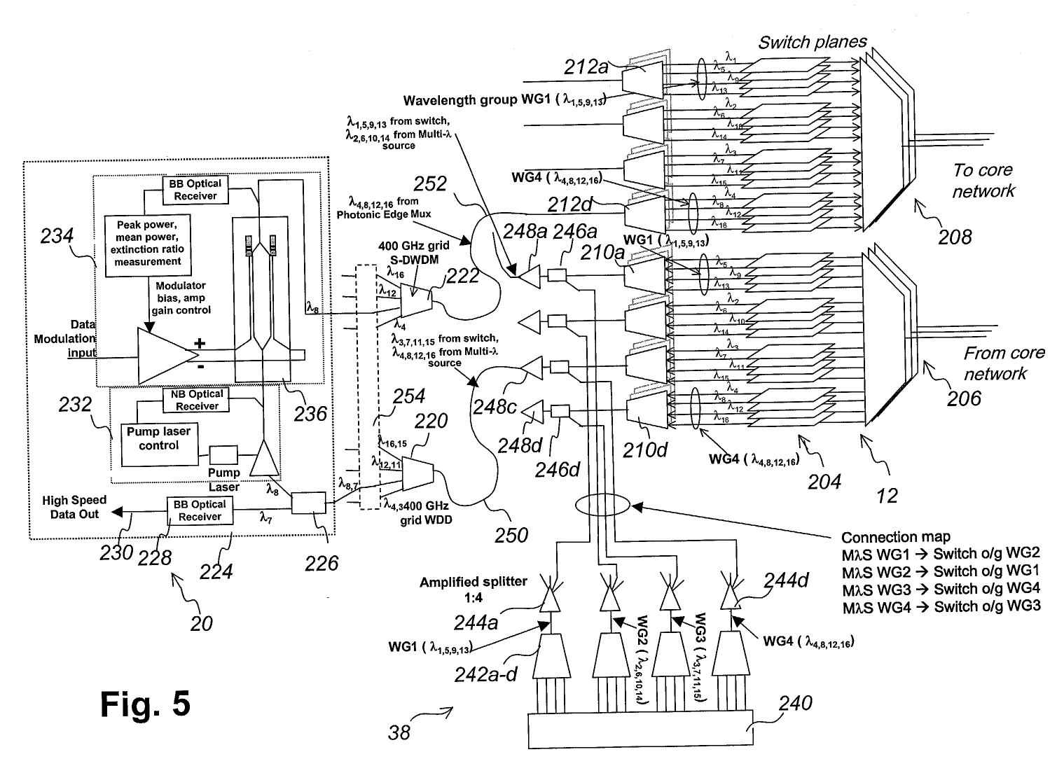

Referring to FIG. 5, there is illustrated, in more detail, a portion of the network of FIG. 1 showing wavelength distribution at the access portion thereof. The network portion includes edge node 12, access node 20 and multiple lambda source 38, each shown in further detail to illustrate lambda distribution in the access portion of the network. The wavelength distribution of FIG. 5 is based upon the wavelength plan of FIG. 2.

FIG. 5 shows a 16 channel DWDM, 400 GHz grid S-DWDM, four phase solution with four carriers per S-DWDM phase. It shows the entire path from the trunk Rx (downstream) port on the way to the access, the switch planes, the downstream S-DWDM multiplexers, the addition of the downstream optical carriers from the MlS that are to be modulated in the CPE,m the far-end (OSP/CPE) demultiplexing and optional patch-panel, the CPE-located treatment of the downstream combined data carrier and unmodulated optical carrier, the modulation of that umodulated carrier and its return to the core network.

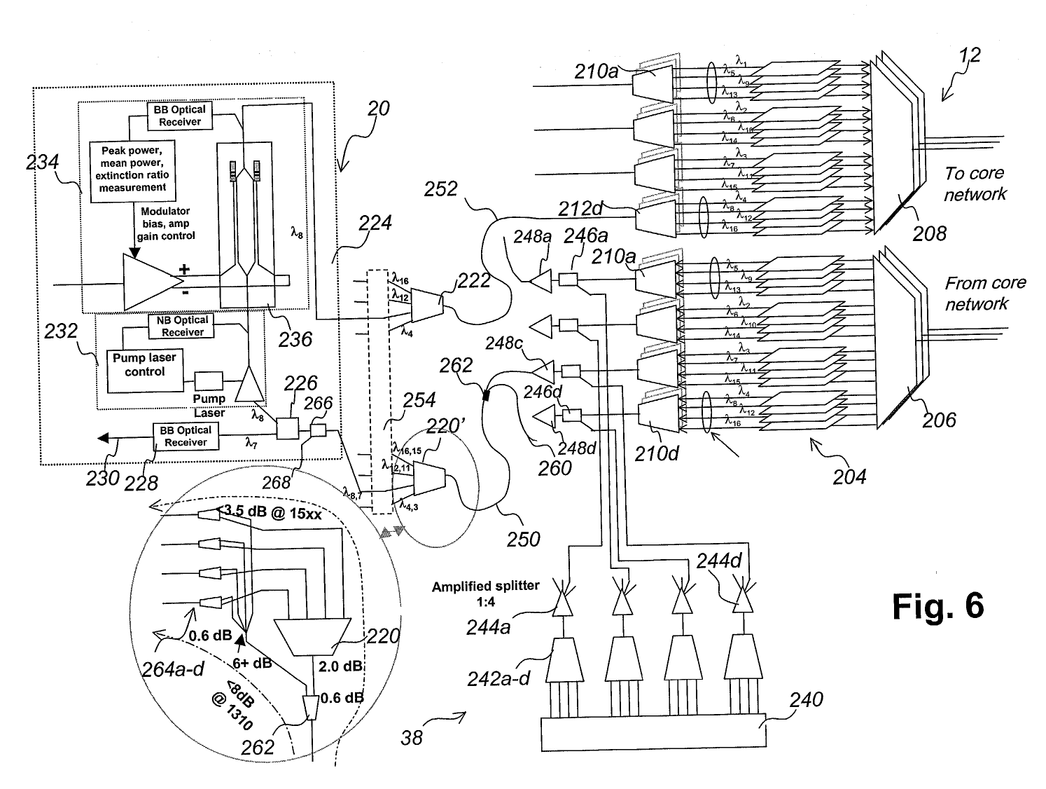

The optional patch panel has not been described before and may, or may not be provided. If it is not provided then each optical carrier downstream pair/upstream carrier is hard-wired to a specific piece of CPE equipment whereas if the patch panel is provided then the CPE can be connected to any of the available spare optical carriers. This doesn't change the traffic handling characteristics of the overall edge node in a non-concentrating edge node, with the same amount of capacity on both sides of the switch but does have a significant impact when the trunk ports are sub-equipped to save port cards and network resources. Of course, with a patch panel this is slow provisioned concentration of the access, not dynamic concentration, but replacing the patch panel with a small switch will allow this to become dynamic. This is discussed with regard to FIG. 6.

The edge node 12 includes a DWDM demultiplexer 206 and DWD multiplexer 208 on the dense wavelength division multiplex (DWDM) core side of the network and plural sparse-DWDM multiplexers 210 and demultiplexers 212 on the access side of the network. The optical plane switches of the core 204 of access node 12 are shown as individual planes though a full connectivity switch or other structures could be used. In the case of a large multi-lambda access node consuming an entire S-DWDM group, the access node 20 includes sparse-DWDM (400 GHz grid) wavelength distributed demultiplexer 220 and multiplexer 222 and a plurality of photonic transport interface modules (PTI) 224, which each have the role of taking in the composite S-DWDM lambda pair, separating the downstream modulated lambda from the downstream unmodulated carrier, passing the modulated carrier to the AN for reception and passing the unmodulated carrier through a modulation process prior to outputting it back to the Edge Node via an upstream S-DWDM multiplexer. Each PTI consists of a de-interleaver 226, a broadband optical receiver 228 and an output for high-speed data 230 on its receive path, and, on its modulation/transmit path, a carrier power gain block and amplitude stabilization loop 232 and a modulation subsystem including a modulation depth and power stabilization loop 234 as well as a high speed modulator driver, driving the modulator 236. The de-interleaver 226 outputs may be reversed to provide even or odd lambda downstream traffic at installated a via a 2×2 photonic switch.

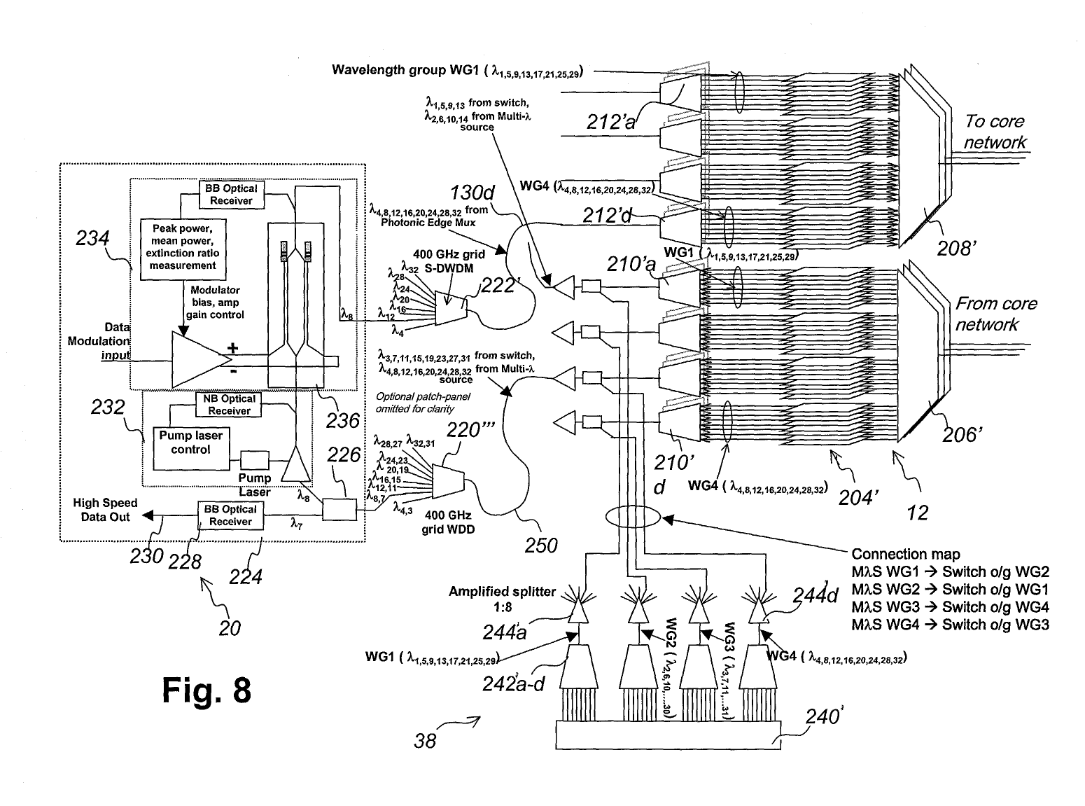

In operation, the Multi-Lambda Source 38 generates sixteen (16) optical carriers on the standard ITU 100 GHz grid (or whatever other spectral plan is to be adopted) as shown in FIG. 2 and 3 for the 16 optical carrier example. The wavelengths from lambda generator 240 of the MLS 38 are grouped or multiplexed by multiplexers 242 into 4 groups of 4 wavelengths that are of the same wavelength composition as the downstream sparse-DWDM frequency plan on the access side of the edge node 12. In FIG. 5 wavelength groups 1 include λ₁, λ₅, λ₉, λ₁₃. Similarly, wavelength groups 2 includes λ₂, λ₆, λ₁₀, λ₁₄, wavelength groups 3 include λ₃, λ₇, λ₁₁, λ₁₅, and wavelength groups 4 include λ₄, λ₈, λ₁₂, λ₁₆. These groups are fed through amplifying splitters 244, (such as an amplifying 8-way splitter such as that manufactured by TEEM Photonics, of Grenoble, France). By locating multi lambda sources near the access modulators link losses can be compensated for by the use of low cost, modest gain erbium doped waveguide amplifiers (EDWA). Similarly, each photonic switch in the core network also compensates for its own insertion loss so that the overall link budget for the network is adhered to. The individual optical feeds are fed into the appropriate outgoing ports via a coupler or interleaver device 246. It is important to note that, for the access fiber port with “wavelength group 1” downstream wavelengths, the unmodulated wavelengths from MRS 38 are not from wavelength group 1, since this would overwrite the downstream data, but are from one of the other wavelength groups 2-4. In the present example wavelength group 2 is used for the unmodulated carrier wavelengths. This result in four (S-DWDM-4) or eight (S-DWDM-8) groups of two wavelengths (one being a downstream signal, the other an unmodulated carrier) being generated with an inter-group spacing of 400 GHz (allowing relatively coarse demultiplexers 180 in the outside plant), with an inter-carrier spacing between the two carriers in the group being a constant 100 GHz. The entire optical structure includes four or eight 400 GHz spaced downstream data streams and four or eight downstream unmodulated carriers. FIGS. 5, 6, 7 show structures using S-DWDM-4, while FIG. 8 uses S-DWDM-8. Considering FIG. 5, the eight wavelengths (four downstream data streams, four optical carriers for modulation and return) are propagated over the outside plant fiber plant, for example the optical fiber 250, to the far end optical sparse-DWDM demultiplexer 220, a 400 GHz channelized optical demux, that drops lambdas 7 and 8 into the PTI 224 of access node 20. The 100 GHz grid optical interleaver 226 (a recursive optical device such as a resonant cavity) separates the two wavelengths lambda 7 and lambda 8. The modulated Lambda 7 carries the downstream data and is fed to the downstream optical data receiver 22, received and converted into an electronic signal and passed via the output 230 out of the PTI and into the access node electronic circuitry (not shown in FIG. 5).

Meanwhile lambda 8, being the optical carrier for the upstream path is passed to the modulation subsystem (loop 234) of the upstream transmitter. The optical carrier lambda 8 passes through the carrier power stabilization loop 232 to ensure that a constant known power level is passed into the modulator 236. The modulator 236 can take many forms, such as an electro-absorbsion modulator, shown in FIG. 5 is an electro-optic Mach-Zehnder modulator, that can be implemented in Lithium Niobate or as an electro-optic polymer modulator, which offers superior economics, integration potential, and lower drive requirements as this technology matures. The modulator also operates within a series of feedback loops, forming the modulator depth, power stabilization loop 234, the nature of which is determined by the properties of the chosen modulator technology. Typically, with a MZ modulator 236, there is a peak power control and an extinction ratio control, controlling the brilliance of “1”s and the closeness to darkness of “0”s, respectively. The output from this passive modulator is then fed through an inverse of the incoming optical demultiplex, in the same wavelength port as before and is fed via optical fiber 252 upstream to the edge node 12. Here the upstream modulated lambda 8 is passed through an access-side port card (not shown in FIG. 5) to the switch core and is coupled straight into the outgoing DWDM multiplexer 208 of the switch. The optical carrier must be of a frequency that directly aligns to the outgoing grid.

The access node 20 may include an optical patch panel 254.

Referring to FIG. 6, there is illustrated the embodiment of FIG. 5 with added components for the Ethernet-based 1300 nm bidirectional (probably TCM) control path. FIG. 6 shows details of how that control path is handled at the field demultiplexer, at the CPE and at the switch-end of the access (from an optical path perspective). The 1310 nm channel includes an input/output port 260 from/to CPE, an optical combiner 262 and a modified WDM “mux 220”. The modification includes a splitter 252 before WDM demultiplexer 220 and a plurality of combiners 264a-d thereafter. A splitter 266 in PTI 224 provides a 1300 nm control 268 patch to/from Ethernet transceiver.

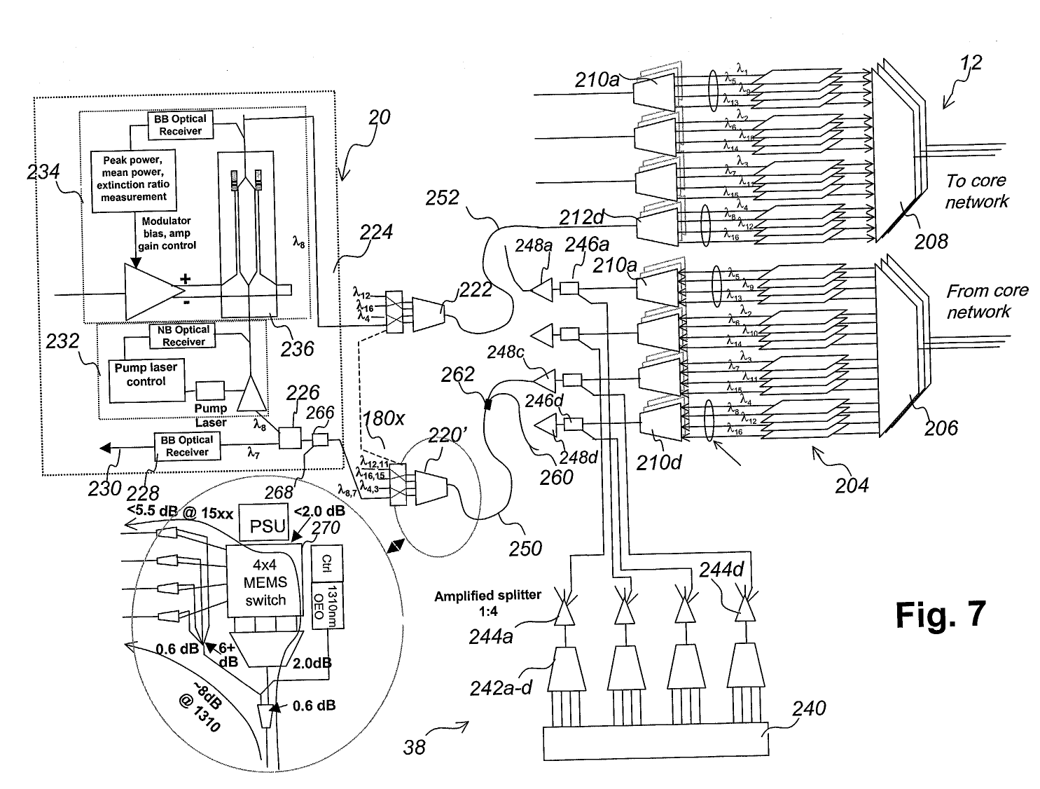

Referring to FIG. 7 there is illustrated in more detail a portion of the network of FIG. 1, showing wavelength distributed at the access portion thereof. This shows an alternative which introduces a remotely controlled square (P×P) switch 270 in the access node S-DWDM demultiplexer (and multiplexer). This allows individual S-DWDM wavelengths to be provisioned over the group of users flexibly, which modifies the lambda-blocking characteristics of the network, especially at partial “fill”. This serves the same purpose of modifying (improving) the lambda blocking levels when concentration is applied to the switch, by making M<N, by allowing a more efficient lambda assignment protocol to be implemented as will be discussed later herein. Since the P×P switch 270 can be configured in “real time” (10s of milliseconds) then a “real time” concentration function, analogous to that of a DLC can be implemented. The unit is powered from a current-limited standard −48 volt CO copper loop feed, limited to 50 mA for reasons of safety. This permits up to ˜1.5 to 2 watts (max) power to be transmitted over each copper loop, or a similar copper pair installed in the access fiber cable from the CO.

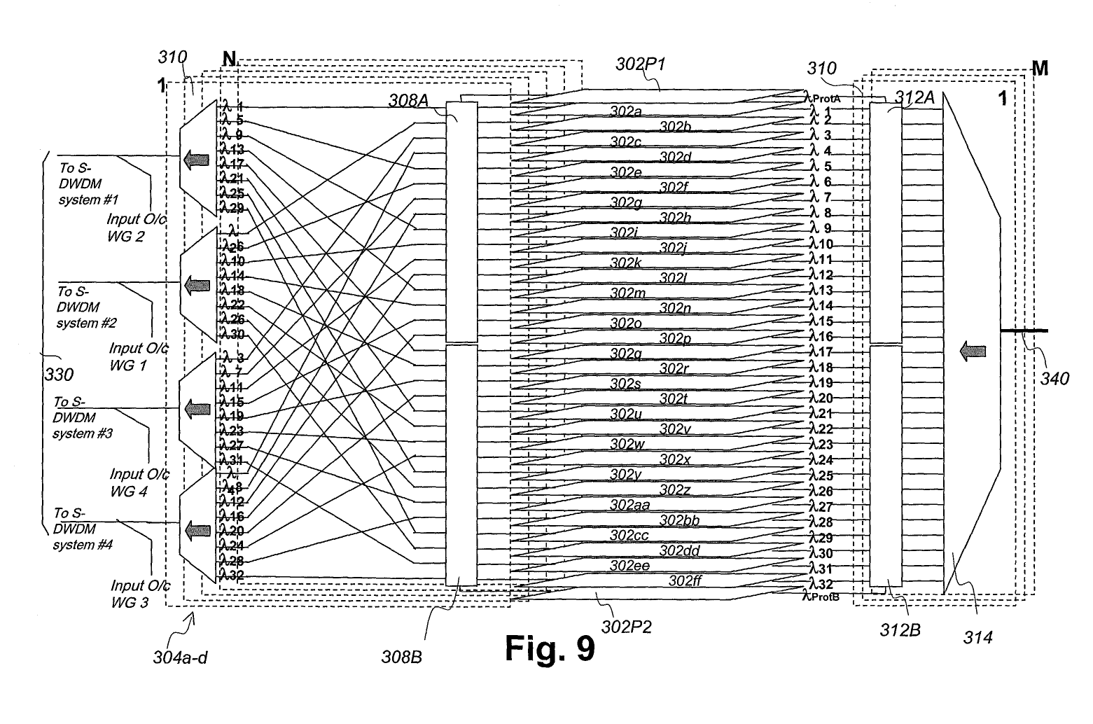

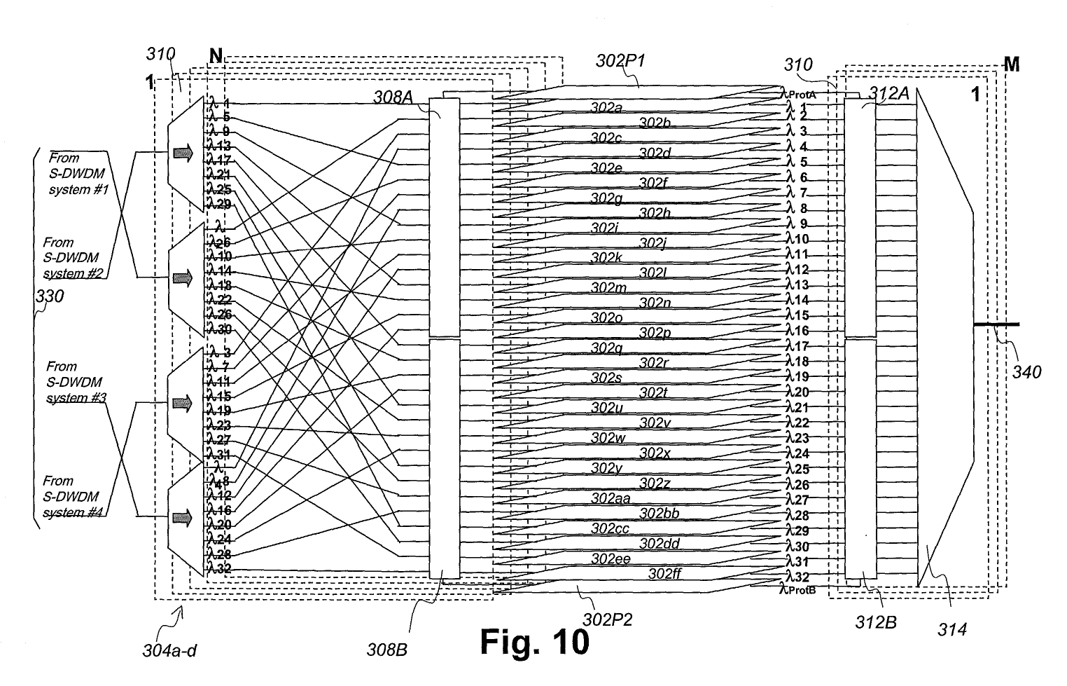

Referring to FIG. 8, there is illustrated in a block diagram in more detail a modified form of FIG. 5, increasing the total number of lambdas to 32, aligning this structure with FIGS. 9 and 10. The changes needed to implement the 32 lambda plan versus the 16 lambda plan of FIG. 5 include increased switch plan in the core 204′ (32 instead of 16) and multiplexer and demultiplexer on the core side (206′, 208′) and access side (210′, 212′) and replacement of the multiplexers and splitters at the lambda source 38, 242′a-d, 244′a-d the multiplexer and demultiplexer in access node 20, 220′″, 222′. It should be understood that it is within the scope of this invention to use any appropriate value of “P”, “M”, “N”, number of DWDM, S-DWDM wavelengths and DWDM←→S-DWDM carrier count, spacing ratio, the numbers used in this document being merely illustrative of current practical values.

Referring to FIG. 9, there is illustrated a downstream portion of a metropolitan photonic network switch configured for implementing the downstream aspect of a second wavelength plan of FIG. 8 in accordance with an embodiment of the present invention. This wavelength plan includes thirty-two (32) DWDM wavelengths with 100 GHz spacing in the core network and on the access side four groups of wavelengths, each group having eight wavelengths spaced 400 GHz apart.

FIG. 9 shows the core-to-access direction with each of the lambdas from N port cards being allocated over M trunk cards (where N>/=M), each trunk and access port card having the same aggregate throughput potential, but with the access port card having more fiber ports with a lesser number of optical carriers per port. The outputs of these S-DWDM access port cards are multiplexed with complimentary groups of optical carriers from the MlS for propagation to the CPE for modulation and return.

Metropolitan photonic switch 300 includes a switch core 302 and a plurality of access port cards 310 each access card including four WDM demultiplexers 304a-d and two protection switches 308A and 308B. The switch core 302 includes protection switch planes 302P1 and 302P2 and lambda switch planes 302a-302ff.

The DWDM side of the switch includes a plurality of trib-cards 310. Each trib-card including two protection switches 312A and 312B and a DWDM multiplexer 314.

On the access side of metropolitan photonic switch 300 wavelength groups carried on respective fiber groups 330 are coupled to respective access port cards 310 while on the core network side of the metropolitan switch 300, each trib-card 310 is coupled to a DWDM fiber 340. The fiber groups 330 include combiners 342 and for receiving fibers 344a-d carrying unmodulated wavelengths of the adjacent wavelength group.

In operation, a wavelength group is input to access card 310 via fiber group 330 including four fibers each carrying up to eight wavelengths. The wavelengths are demultiplexed into individual wavelengths and cross connected and directly shuffled into wavelength order for input to the protection switches 308A and B prior to input to the appropriate lambda plane switch. On the output of the lambda plane switch, the ports are similarly protected by protection switches 312A and 312B before being coupled to the output DWDM multiplexer 314, which outputs to the single fiber 340 having thirty-two (32) 100 GHz-spaced DWDM channels.

Referring to FIG. 10, there is illustrated a portion of a metropolitan photonic network switch for upstream traffic. FIG. 10 shows the access-to-core direction, with the return path from the CPE to the edge node and core network. The returned, now modulated, optical carriers are the same frequency as the downstream unmodulated optical carriers which means that they are offset one frequency sequence # or wavelength sequence # from the downstream data streams frequency or wavelength sequence number (11,12,13 . . . 130,131,132 are the wavelength sequence #'s). Hence the input connections to the upstream access side of the Edge switch node have to be +11 offset from the downstream connections for S-DWDM groups with odd numbered downstream traffic lambdas and have to be −11 offset from the downstream connections for S-DWDM groups with odd numbered downstream traffic lambdas. This is readily achieved by reversing the upstream connections of S-DWDM group 1, 2, 3 and 4.

It's the cross-over of the pairs of S-DWDM groups coupled with the same cross-over on the paths in from the lambda sources (shown as the connection map on FIG. 5) that allows all the lambdas to be used in both directions, thereby allowing the switch (and network) to be fully loaded.

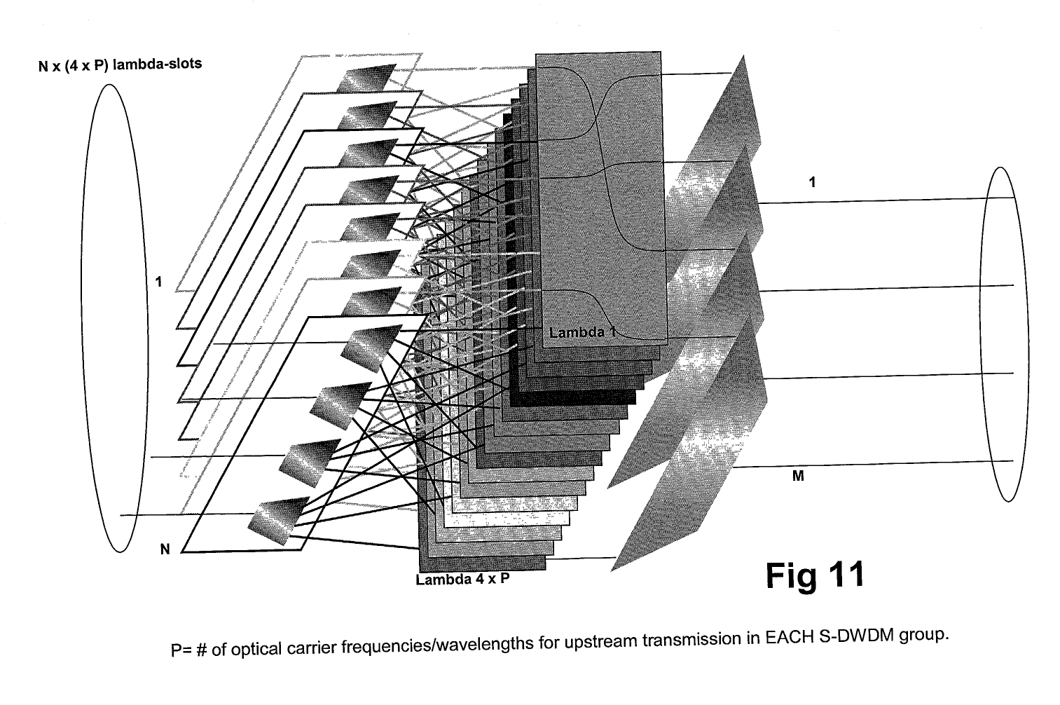

Referring to FIG. 11, there is illustrated an edge node in accordance with an embodiment of the present invention. In a communications network often the access infrastructure will be overbuilt, due to the difficulty of going back to reinforce it later, since the civil engineering costs massively outweigh the other costs and are best done once. Hence all of the outside plant cable will likely be placed at once with spare capacity in that cable. An example of this is the way that the old POTS copper access was built.

Similarly, it is expected that, as metro direct fiber-to-the-building/user access networks are built, [especially those with a “lambda-on-demand” capability, requiring the provision of a dark lambda (instead of a dark fiber) into customer premises, whether or not they are immediately taking lambda service], so excess fiber or, due to the fiber/lambda mapping, excess potential lambda capacity will be provided. This allows for flexibility in handling growth, or unanticipated local capacity “hot-spots” without major fiber placement civil works, thereby permitting economical rapid response. This is, of course, very important in a “lambda-on-demand” network.

This is one of the reasons the S-DWDM channel count may be set somewhat on the high side. The present example uses 8 lambdas per S-DWDM fiber, although it is expected that, in many cases the average utilization, especially in the early days, will be much less than this, typically 2, 3 or 4 lambdas average over the installed plant. Clearly this has economical impacts that have to be handled, both in the access, and the switched core network.

In the access domain, in the case of a single fiber-pair into a given area to be served, the only option to preserve margin for growth is to sub-equip the number of lambdas per fiber. However, in areas where multiple fiber pairs feed an area the choice is between having a subset of the access fibers in service, relatively heavily loaded, with the balance being dark, or having most/all of the fibers in service but with relatively few lambdas active on each fiber. Both approaches use the same amount of fiber, but different amounts of equipment and have different response processes and hence times to add more subscribers. The dark-fiber variant having trades savings in deployed access equipment for the need so to do once the demand for the lambda materializes.

For instance, in a business park with about 20-30 tenants, four pairs of fibers with 8 channel S-DWDM may be run in, on the assumption that, day one about 10 of the tenants will take lambda service, for an example average load of 2.5 active lambdas per fiber on all four fibers or for one fiber fully active, one to be one-quarter active and the other two pairs being inactive and unequipped. However the 11th tenant to come on-line may be a new broadband ISP and he may want (as an example) 12 optical carriers. This could be handled without disruption to the infrastructure, since there are 22 spare unused lambdas in the capacity of the four pairs of fiber×8 lambdas per fiber-pair.

However, when planning a network for such churn, growth flexibility, it is necessary to decide just how far into the network the spare capacity/latent capacity to handle this churn should extend and where the excess capacity is to be removed or throttled (I.e. where the concentration points are to be placed).. The under-utilization of network resources may be acceptable in the access, since the alternative, that of perpetual additional cable placement is even less palatable, and the access plant, being relatively short distance, and using relatively low-cost technology, may tolerate this under-utilization. The switched core network will not, so we have to examine ways to place an adequate “dark lambda” capacity and capability in the access plant, while protecting the core network from the worst of excess capacity.

This means that we need to turn the edge photonic switch into a provisionable lambda concentrator, so that we can sub-equip trunk ports and/or switch planes down to a level whereby the residual components are fully enough loaded to give good network economics while reserving enough spare capacity to handle routine traffic churn in terms of subscribers coming and going—including the occasional broadband ISP.

Consider the case where a telco has been deploying the edge switch with S-DWDM access and has (arbitarily) chosen to design his 8 channel S-DWDM access plant such that the average load is 2.5 lambdas per fiber pair. This may be due to the size of user-groups in a geographical location or as a result of conscious traffic planning, capacity planning or a mixture of both. Since each 32 lambda (4×8 lambda) S-DWDM card (FIG. 11 only shows 16 lambdas for simplicity but 32 is more likely) supports 4 separate S-DWDM groups, the telco will, on average, provision 10 optical carriers per access card out of 32 potentially available, keeping the rest in reserve for future growth. This initially adds cost per provisioned circuit to the access portion of the network, but the trunk side of the switch, and the rest of the supporting core network can be sub-equipped. With the much greater aggregation of capacities, the core network can handle routine capacity churn, even that of adding the occasional 12 carrier broadband ISP, within a few percent spare capacity. Then, as the network as a whole grows, the telco can physically provision more trunk equipment and/or switch planes. These notes deal with provisioning of trunk equipment only, but it should be noted that an equivalent approach can be applied to switch planes, which likewise can be sub-equipped in lieu of sub-equipping trunk port cards or as well as sub-equipping trunk port cards.

Again, illustrating this with an example, consider a 32 lambda, 16 port switch. This switch would have the capability of supporting 256 bidirectional optical carrier paths, so could support up to eight 32 lambda (four×8 lambda) access cards at full traffic load, by providing eight 32 channel trunk port cards, and an equivalent amount of entire core network infrastructure behind them. However, at an average actual lambda load in each S-DWDM link of 2.5 out of 8 possible lambdas (as assumed earlier), then only 2.5/8th (or 5/16th ) of this trunk port capacity and core network capacity is being used, hence 5.5/8th or 11/16th of this capacity is being wasted. Consequently 4-5 of the 8 trunk port cards can be omitted (and provisioned later if/when traffic grows). Let us assume that 3 trunk ports are deployed. Then, at an average of 2.5 active lambdas per access fiber (out of 8 possible) there are an average of 10 active lambdas per (four×S-DWDM) access card, which, at eight access cards, gives a total of 80 lambdas out of a possible 256 in traffic at the switch node, which can then be mapped to 80 out of a possible 96 channels on the three core side DWDM trib cards. This leaves 16 spare (20%) as a shared resource to handle churn, growth. So,considering an example of 3 going to 7 lambdas overnight on one S-DWDM port, as a new high bandwidth business starts up, while this more than doubles the load on its associated S-DWDM feed, it only uses 25% of the spare capacity (I.e. 0.25×20% of the total capacity or 4%) which is readily handled within the available port capacity.

However, all this ignores the fact that, instead of having simple access into a non-blocking switch fabric to do the concentration, we have, in this case, a lambda-plane switch, is comprising multiple small (8×8, 16×16) parallel fabrics, one per lambda-colour and we are entering and leaving via WDM technology, which says we are not free to map any input to any output as we are in a conventional concentrator.

The purpose of the S-DWDM lambda-allocation algorithm (SLAA) is to make the array of small switches exhibit a behaviour for traffic engineering/concentration purposes that is much more benign than that of individual small switches, and which approaches that of a single large switch, by controlling the allocation of the optical carrier frequency to be provided to each customer.

Consider, as a benchmark mindlessly simple lambda-allocation algorithm, in the case of 8 of the aforementioned access cards, three trunk cards. This algorithm, an illustration of an inadequate algorithm, is as follows:

Algorithm 0.

On each S-DWDM link, allocate the first customer to the first lambda (Lambda 1) of the S-DWDM group, the second customer to the second S-DWDM Lambda (Lambda 2), etc. This can also be expressed as “When a subscriber is to be attached to the S-DWDM group, then the next available wavelength in that group is allocated. If this wavelength cannot be handled on the trunk side then the subscriber is blocked.”

The problem with this algorithm is that, (if, as an example we have equipped three trunk port cards) then as soon as ANY subscribers are allocated to the fourth appearance of a given S-DWDM group (and there are 8 of each S-DWDM group in this example), then that subscriber will be blocked, because there is not a fourth Lambda 1 available on the port card. This very early onset of significant partial blocking will set in very early (at very low traffic levels) for any lambda-allocation algorithm that allocates lambdas within each S-DWDM group, without consideration of the allocations within other S-DWDM groups or Trunk port cards.

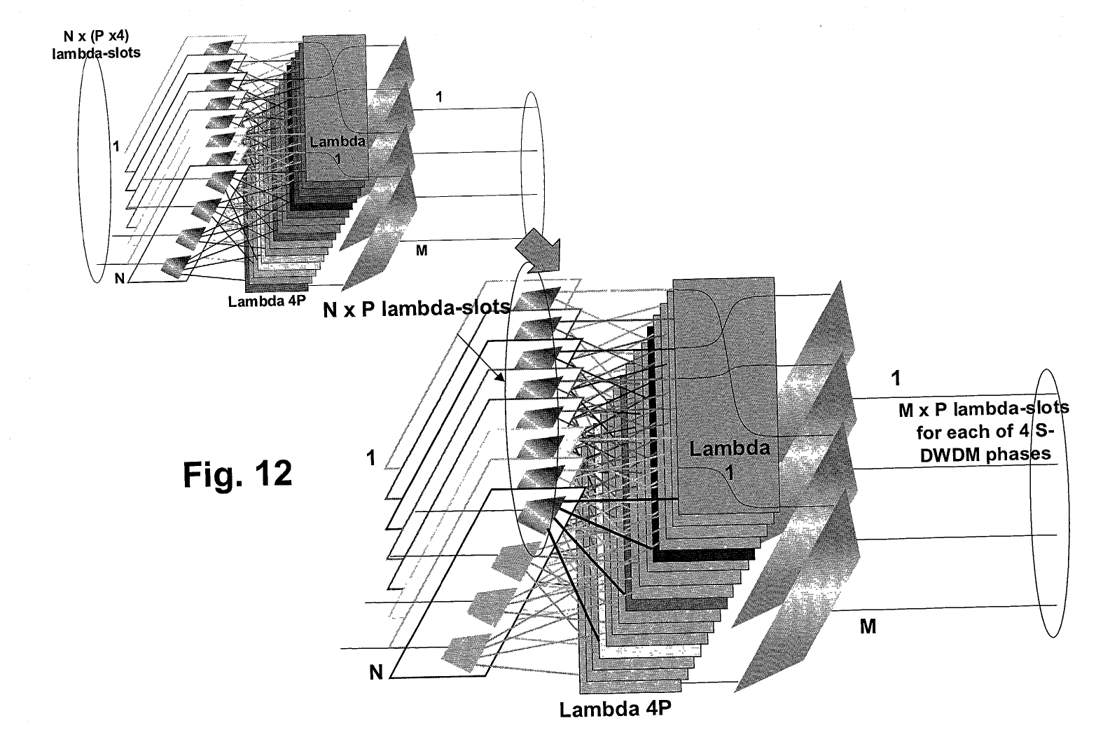

Referring to FIG. 12, there is illustrated the edge node of FIG. 11, organized to provide lambda concentration in accordance with an embodiment of the present invention. In order to model the behaviour of this and other, hopefully better, algorithms some simplifications and clarifications can be made. The first is that, since each S-DWDM group on each access card only share/contends for core resources with only the same S-DWDM groups on other access cards and not with different S-DWDM groups on the same card or different cards, we can slice through the switch at the S-DWDM group level and only use/consider the core resources associated with that group in the model. This is shown diagrammatically in FIG. 12.

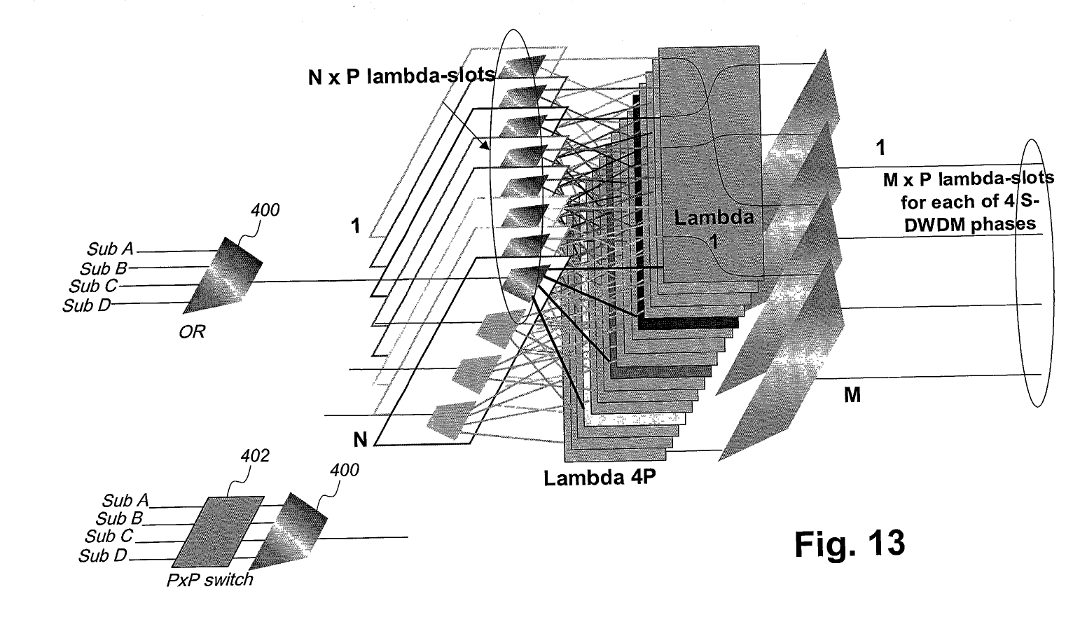

Referring to FIG. 13, there is illustrated the edge node of FIG. 11, organized to provide lambda concentration in accordance with a second model of the present invention. The two forms of Outside Plant Access (OSP) structure, being dedicated S-DWDM lambda to each specific subscriber 400 or an ability to allocate any spare S-DWDM lambda to each sub as the need arises need to be considered 402. The first example doesn't need or use an OSP patch panel or switch as part of the lambda blocking management, whereas the second does.

The four S-DWDM phases are interleaved but share no lambda values and have no connections between them. Hence, in analysing the behaviour of the concentration process, we can simplify the model to just analyse the instantiations of one S-DWDM group being mapped to the available sub-group of lambdas on all of the available trunk port cards

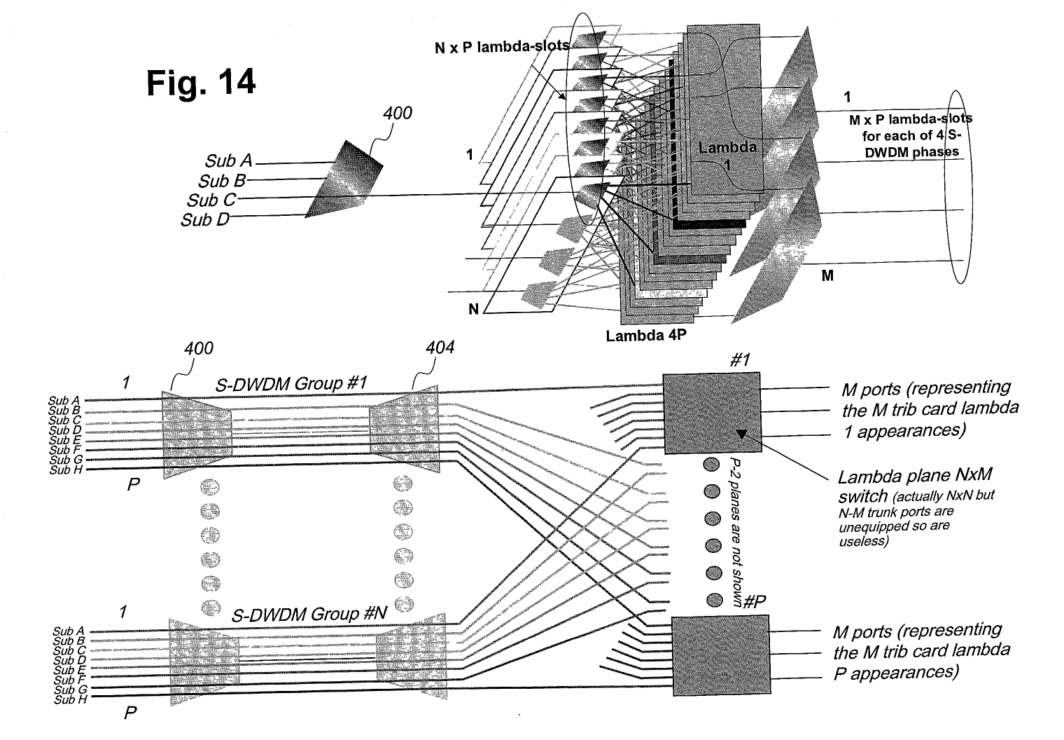

Referring to FIG. 14, there is illustrated the edge node of FIG. 11, organized to provide lambda concentration in accordance with a more detailed representation of the top path in FIG. 13. A fixed mapping scenario for S-DWDM lambdas, though to the wavelength resource pool within the DWDM streams for the DWDM lambdas associated with the specific S-DWDM group are shown here. From this it is apparent that the back-to-back S-DWDM multiplexer 404, demultiplexer 406 acts as a parallel connection bus from each OSP location (1 to N) with one “wire” of the P-wide bus (where p=number of lambdas in each S-DWDM group) being connected to one input on “P” different “N×M” switches Hence there is (and should be) only one connection from each S-DWDM group into each switch plane. Since the trunk side is equipped with only “M” port cards, and therefore has only “M” instantiations of any value of lambda, then, whenever the “N” S-DWDM access systems between them attempt to connect to more than M instantiations of the same lambda the path will be blocked. Since the path is fixed-allocated to specific subscribers (and vice versa) then that subscriber would be denied access. This is only not a problem when N=M, since then there are enough instantiations of each lambda value for non-blocking access.

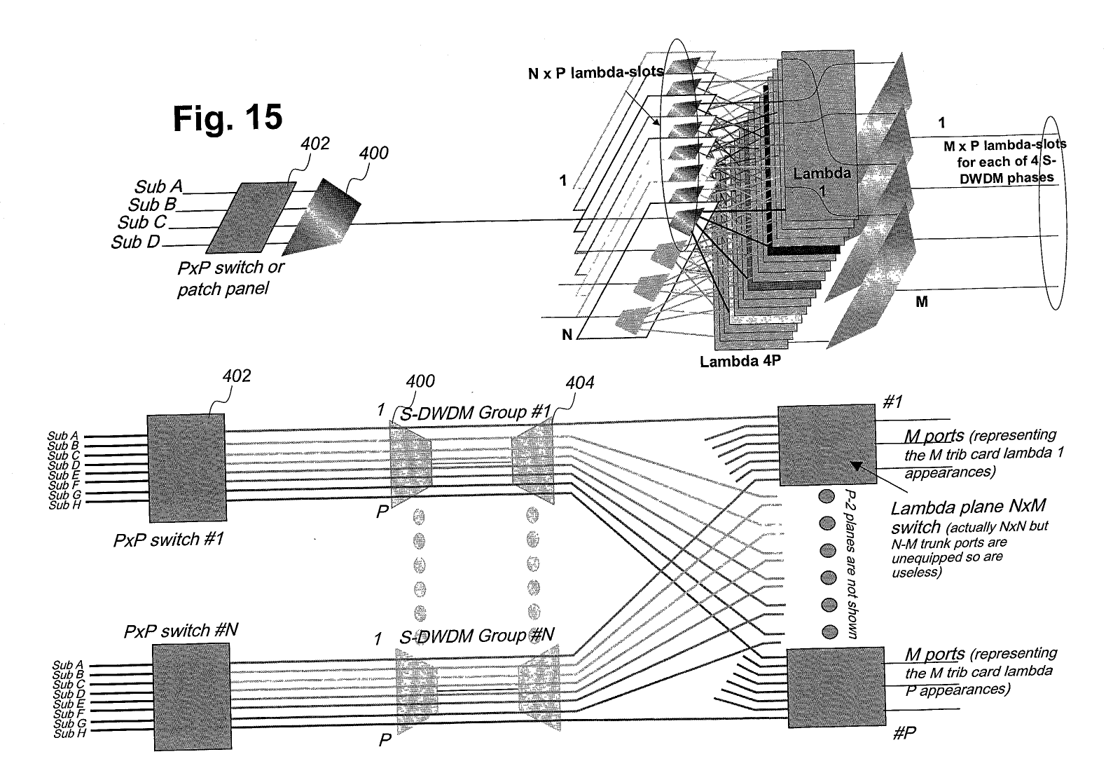

Referring to FIG. 15, there is illustrated the edge node of FIG. 11, organized to provide lambda concentration in accordance with a more detailed representation of the bottom path of FIG. 13. The second scenario, allows the subscribers to be connected to appropriate spare lambdas, under control of an appropriate SLAA, requires a method of changing the individual connections between the subscriber and the specific inputs (and outputs) of the S-DWDM OSP multiplexer. This can be done rapidly by associating the OSP multiplexer 400 with a small remotely controlled switch 402 (P×P) or much more slowly by use of a patch-panel for provisioned lambdas in a transport network.

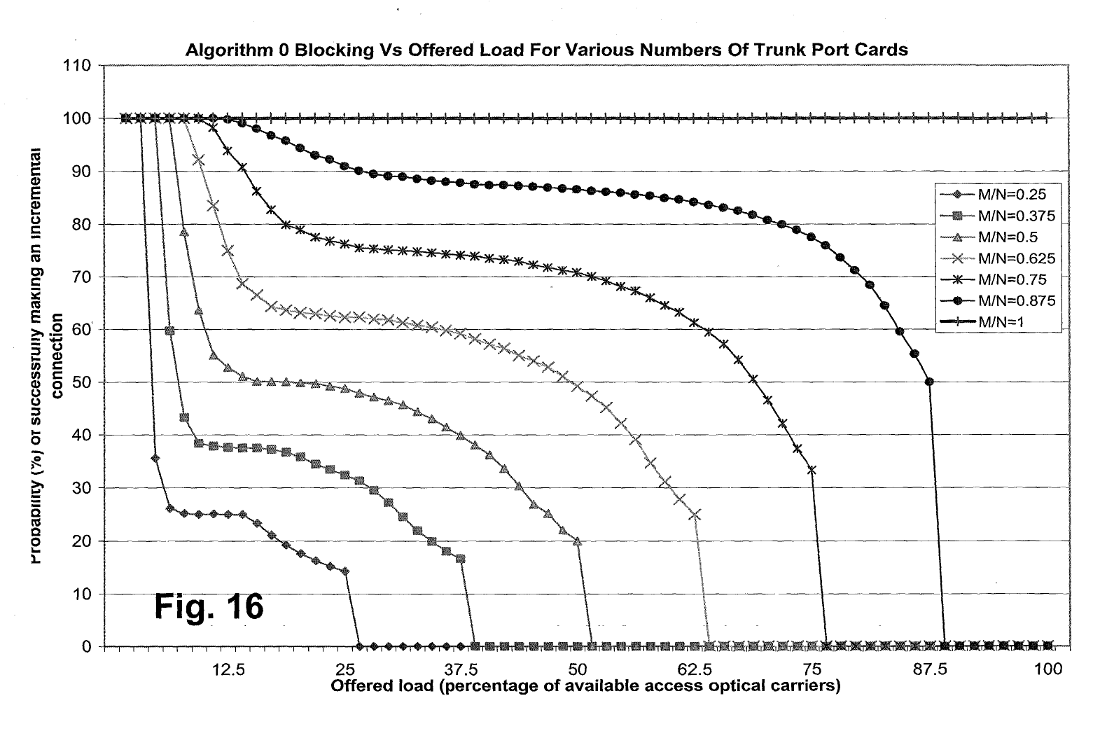

Referring to FIG. 16, there is graphically illustrated modeled results for algorithm 0. The tool sets up a specific load level in a random manner, but uses the algorithm, and measures whether or not it could add one more random connection, over 1000 iterations, collecting the statistics on its success rate (e.g. 562 out of 1000 succeeded=56.2% connectivity), then step to the next higher load level and repeat the process. This was done for each of the algorithms over the range of 2-8 trunk trib cards, for the case of 8 access trib cards, and 8 lambdas in the S-DWDM block. The results for algorithm 0 are shown in FIG. 16. This represents the best that can be achieved without deploying and actively using an OSP flexibility point in the traffic management of the node. What it shows is that the behaviour of the overall sub-system is indeed benign and non-blocking when trunk capacity equals total access capacity (lit+dark lambdas), but that the approach is very sensitive to reduction in trunk port capacity, providing a level of partial blocking at very low applied traffic loads. This is sufficiently extreme as to be effectively non-responsive to the addition of any level of trunk port that results in a a traffic handling capacity below non-blocking. To illustrate this the traffic load achievable as a function of port traffic capability at a level of 99% unblocking/1% blocking is captured in the following table.

| | Traffic handling @ 1% | Achievable fill of trunk |
|---|---|---|
| Trunk capacity | block (% of | ports (% of equipped |
| (% of non-blocking) | presented S0-DWDM | cap @ 1% block) |
| 87.5 | 14.8 | 16.9 |
| 75 | 10.9 | 14.5 |
| 62.5 | 8.6 | 13.8 |
| 50 | 6.4 | 12.8 |
| 37.5 | 4.7 | 12.6 |
| 25 | 3.2 | 12.6 |

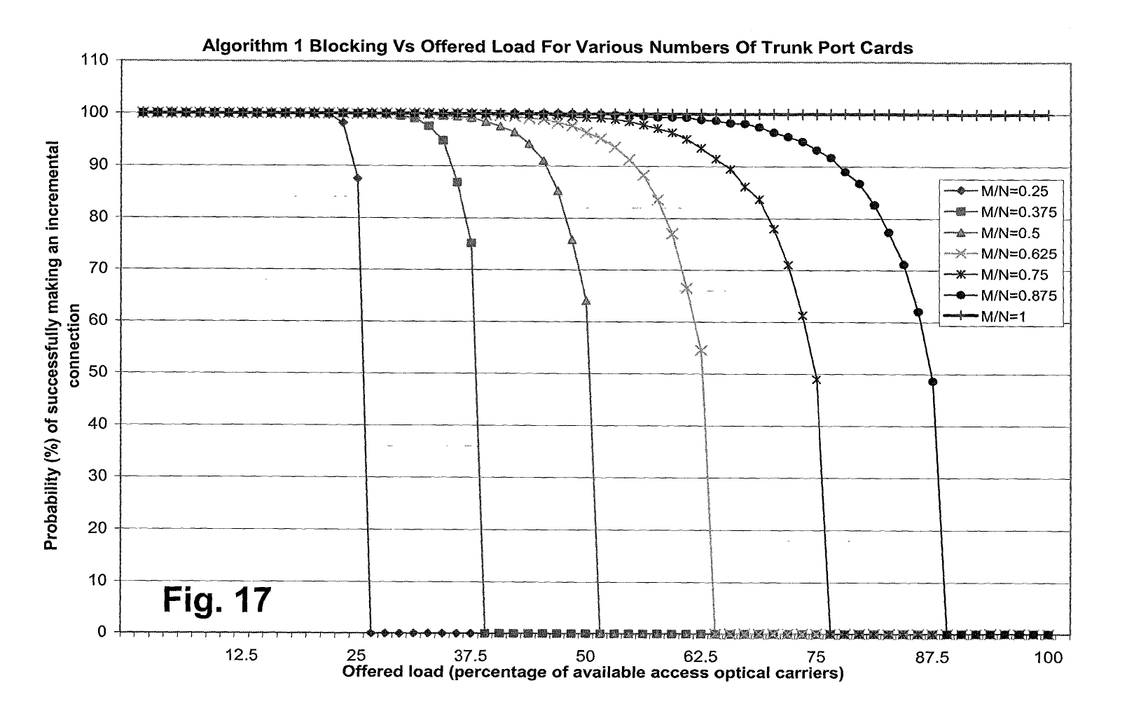

Referring to FIG. 17, there are graphically illustrated modeled results for algorithm 1. Algorithm 1 is a more sophisticated variant of algorithm 0, made possible by taking into account the availability of trunk card lambdas, and using the OSP switch/cross-connect 402 (or, in a slow manually provisioned system, the optical patch panel, 254) to configure that lambda to the user. It can be expressed as “When a subscriber is to be attached to the S-DWDM group then the next available wavelength in that group that can also be handled on the provisioned trunk cards (taking into account their availability) will be allocated to the user) If no wavelength is available on both the S-DWDM group and on the trunk lambda population then the subscriber is blocked.” This has a feedback mechanism from the availability table of trunk port cards which is convolved with the availability table of the S-DWDM lambdas in the S-DWDM group of interest, and the first match is picked. The results of this, algorithm, while not perfect, are substantially improved, relative to those of Algorithm 0, and warrant the inclusion of the patch panel or OSP switch module. To illustrate this the traffic load achievable as a function of port traffic capability at a level of 99% unblocking/1% blocking is captured in the following table.

| | Traffic handling @ 1% | Achievable fill of trunk |
|---|---|---|
| Trunk capacity | block (% of presented | ports (% of equipped |
| (% of non-blocking) | S0-DWDM lambdas lit) | cap @ 1% block) |
| 87.5 | 62.5 | 71.4 |
| 75 | 54.7 | 72.9 |
| 62.5 | 46.9 | 75.0 |
| 50 | 39.1 | 78.2 |
| 37.5 | 31.3 | 83.5 |
| 25 | 23.5 | 94.0 |

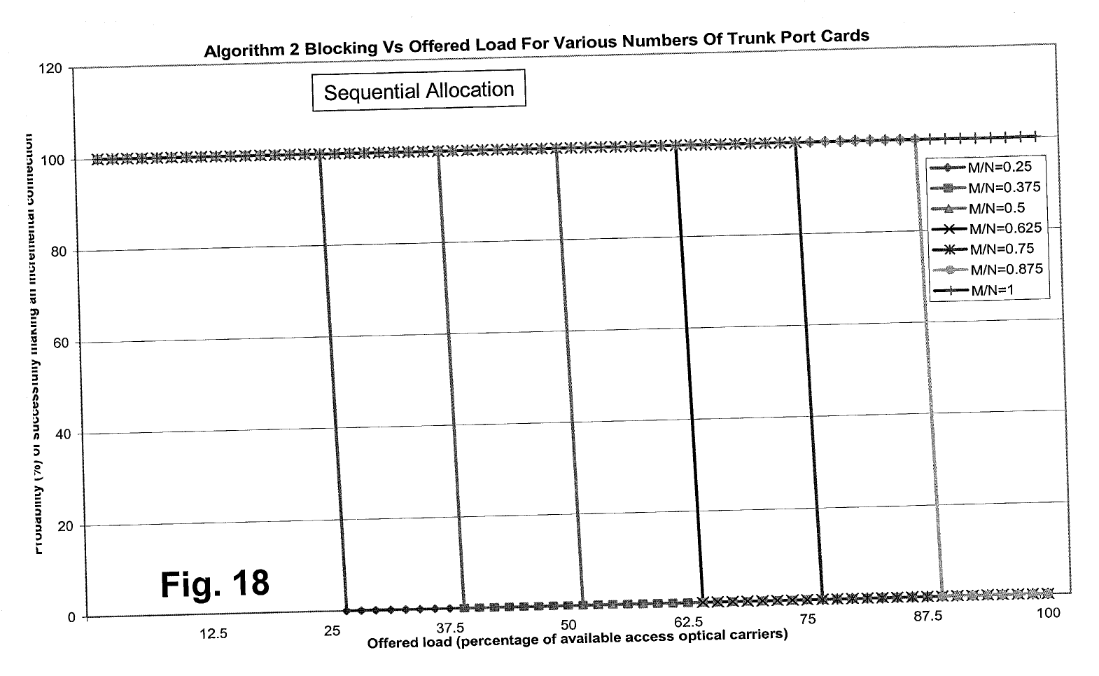

Referring to FIG. 18, there is graphically illustrate modeled results for Algorithm 2. This algorithm to attach a new subscriber is “When a subscriber is to be attached, the free wavelengths available in the S-DWDM group will be noted. All number of available trunk ports (unused trunk ports) for each one of these wavelengths will be collected/calculated. The wavelength allocated to the subscriber will be that wavelength that is both available on the S-DWDM group and has the highest number of instantiations available on the trunk ports.” The result is an inherent fairness, equality of allocation that keeps the trunk load smooth ensuring that, up to the port capacity limit, ports can always be allocated. The preceding examples show the value of the OSP switch/patch panel 402 in the cases where the edge-node is used as a concentrating node, eliminating/reducing the “dark lambda” overhead in the core network, while still permitting a scalable, evolvable solution.

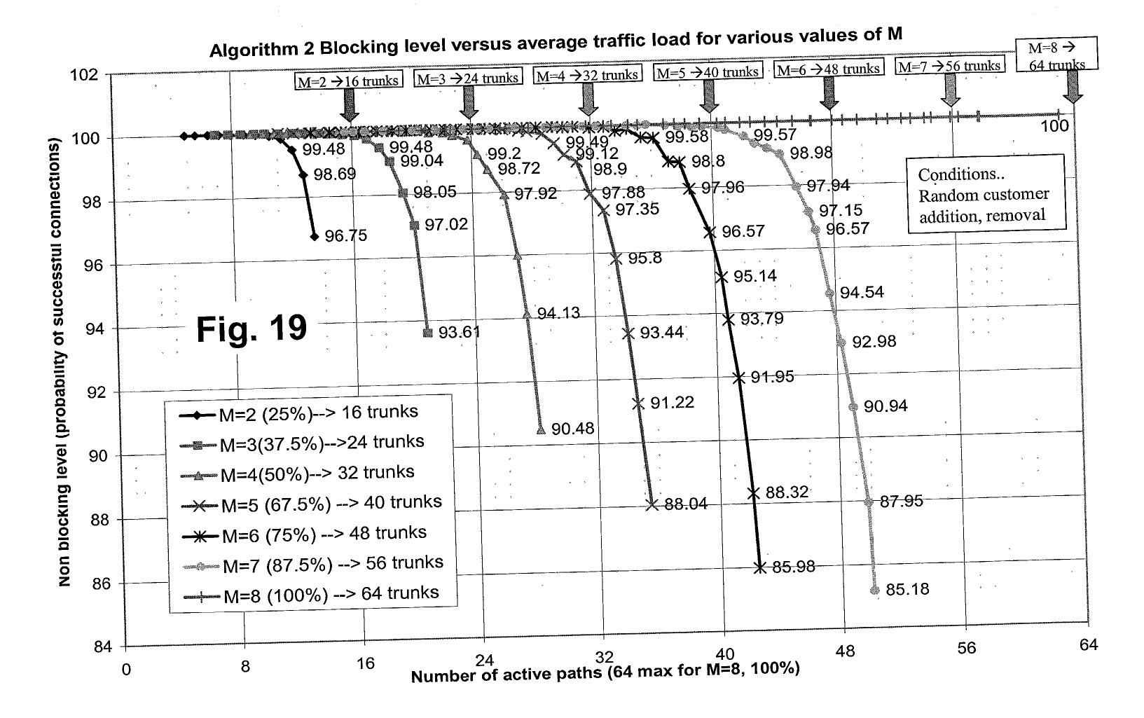

The following sequence of graphs is presented in a slightly different format to the last ones in that the horizontal axis is in percentage of the available trunks. As can be seen from FIG. 19, blocking becomes serious above ˜70%.

Referring to FIG. 19, there is graphically illustrated results for Algorithm 2 under dynamic random traffic ingress and egress conditions. If a telco is provisioning a system for the first time, Algorithm 2 will operate in a particularly benign environment. However in real life, subscribers will require attachment (ingress) and disconnection (egress) in a random sequence both in location and time. This will put a greater strain on any algorithm so this was modeled in order to ascertain the behaviour of this algorithm in real-life random connection/disconnection situations where an average traffic level is known but the actual number of subscribers perturbates around that value. FIG. 19 provides results for the following values of M: M=2; M=3; M=4; M=5; M=6; M=7; and M=8.

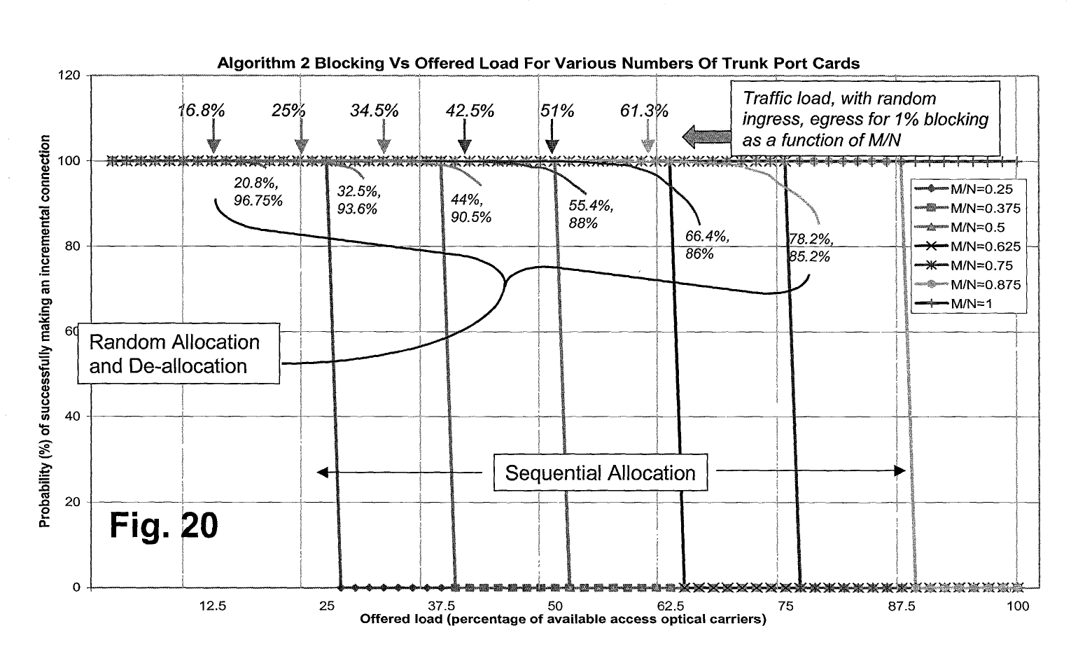

In FIG. 20, the preceding series of curves of the dynamic performance of algorithm 2 have been overlaid on to the best result achievable by static sequential provisioning, and, as expected, there is a fall-off of performance. The 1% probability of blocking points have been plotted along the top of the chart. Despite the reduction in performance, this is still a very acceptable algorithm for extracting relatively high efficiencies from the edge switch equipment in a concentrating mode.

Numerous modifications, variations and adaptations may be made to the particular embodiments of the invention described above without departing from the scope of the claims, which is defined in the claims.

What is claimed is:

1. A method of optical wavelength allocation in an photonic network comprising the steps of:
generating a first plurality of optical wavelengths compatible with a first grid spacing at a first location in the network;
selecting a predetermined subset of wavelengths from the first plurality of optical wavelengths; and
transmitting the predetermined subset of wavelengths to a second location that is compatible with a second grid spacing greater than the first grid spacing.

2. A method as claimed in claim 1 wherein at least one of the subset of wavelengths is an unmodulated wavelength.

3. A method as claimed in claim 1 wherein at least one of the subset of wavelengths is a data modulated wavelength.

4. A method as claimed in claim 1 wherein the first grid spacing is a dense mode spacing.

5. A method as claimed in claim 4 wherein the first grid spacing is 100 GHz.

6. A method as claimed in claim 4 wherein the first grid spacing is 50 GHz.

7. A method as claimed in claim 1 wherein the second grid spacing is a sparse mode spacing.

8. A method as claimed in claim 7 wherein the first grid spacing is 400 GHz.

9. A method as claimed in claim 7 wherein the first grid spacing is 500 GHz.

10. A method of optical wavelength allocation in an photonic network comprising the steps of:
generating a plurality of optical wavelengths compatible with a first grid spacing at a first location in the network;
forming a group of wavelengths by grouping selected wavelengths; and
transmitting the group of wavelengths to a second location that is compatible with a second grid spacing greater than the first grid spacing in the network.

11. A method as claimed in claim 10 wherein at least one of the subset of wavelengths is an unmodulated wavelength.

12. A method as claimed in claim 10 wherein at least one of the subset of wavelengths is a data modulated wavelength.

13. A method as claimed in claim 10 wherein the first grid spacing is a dense mode spacing.

14. A method as claimed in claim 13 wherein the first grid spacing is 100 GHz.

15. A method as claimed in claim 13 wherein the first grid spacing is 50 GHz.

16. A method as claimed in claim 10 wherein the second grid spacing is a sparse mode spacing.

17. A method as claimed in claim 16 wherein the first grid spacing is 400 GHz.

18. A method as claimed in claim 16 wherein the first grid spacing is 500 GHz.

19. An optical switching node for a photonic network comprising:
a photonic switch core having a plurality of inputs and a plurality of outputs and capable of connecting any input to any output;
a first wavelength division demultiplexer coupled to a subset of the plurality of inputs for demultiplexing a core optical signal having a first multiplex density into optical channels; and
a first wavelength division multiplexer coupled to a subset of the plurality of outputs for multiplexing any optical channels connected to it into an access optical signal having a second multiplex density;
the second multiplex density being higher than the first.

20. An optical switching node as claimed in claim 19 wherein the second multiplex density is k times the first optical density, where k is an integer.

21. An optical switching node as claimed in claim 20 wherein the first wavelength division multiplexer includes N ports connected to N wavelength plane switches.

22. An optical switching node as claimed in claim 19 further comprising a second wavelength division demultiplexer coupled to a second subset of the plurality of inputs for demultiplexing an access optical signal having the second multiplex density into optical channels.

23. An optical switching node as claimed in claim 22 wherein the second multiplex density is k times the first optical density, where k is an integer.

24. An optical switching node as claimed in claim 23 wherein the first wavelength division multiplexer includes N ports connected to N wavelength plane switches.

25. An optical switching node comprising:
a photonic switch core operable to consolidate wavelengths from access multiplexers into a dense wavelength division multiplexed (DWDM) signal for transmission in a core network; and
including a multi-wavelength source for generating DWDM quality wavelengths for supplying the access multiplexers with unmodulated wavelengths upon which to multiplex data packets.

26. An optical switching node as claimed in claim 25 wherein the photonic switch core includes a predetermined number of ports on an access side.

27. An optical switching node as claimed in claim 25 wherein the photonic switch core includes a predetermined number of ports on a core network side.

28. An optical switching node as claimed in claim 27 wherein the predetermined number of ports on an access side is N and the predetermined number of ports on an core network side is M and N is greater than M.
